(19) United States
(12) Patent Application Publication
(10) Pub. No.: US 2003/0037227 A1
(43) Pub. Date: Feb. 20, 2003

(54) Processor enabling exception handling to be set by program

(75) Inventor: Katsunobu Nomura, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/097,375

(22) Filed: Mar. 15, 2002

(30) Foreign Application Priority Data
Aug. 15, 2001 (JP) 2001-246567

(51) Int. Cl. G06F 9/00

(52) U.S. Cl. 712/244

(57) ABSTRACT

The processor comprises: a regular processing unit (34) performing processing in accordance with command codes supplied from user program; and an exception handling command unit (36) that, when an exception occurs, selects an operation and supplies a corresponding command code to the processing unit. The exception handling command unit has (i) an exception handling command memory (50) that stores exception handling commands corresponding to operation IDs, (ii) a selected operation ID register (52) storeing the operation IDₛ set using the user program, (iii) an exception identification unit (58) receiving an exception notification signal generated when an exception event occurs and determining a prescribed exception event, and (iv) an exception handling command selection/output unit (60) that reads from selected operation ID register operation ID corresponding to the exception identified by the exception identification unit, and outputs a command code of the exception handling command according to operation ID.

### BACKGROUND OF THE INVENTION

1. Field of the Invention

The present invention relates to a processor that performs prescribed data processing, and more particularly, to a processor that permits an operation performed upon the occurrence of an exception to be freely set using a user program.

2. Description of the Related Art

A processor that performs prescribed data processing, such as a CPU or a digital signal processor, must be able to perform a desired exception handling operation when an exception event occurs during data processing. Examples of such an exception event include the occurrence of overflow, underflow or zero division during an arithmetic operation. When this type of exception occurs, normally an exception notification signal is output by an arithmetic unit such as an ALU, and in response thereto, an interrupt is generated and an exception handling program managed by the OS is executed. Therefore, in general it is not easy to freely configure the performance of an exception handling operation by a user program.

This program describes a processing sequence to execute a desired operation using an arithmetic unit comprising a processor, and refers to a program converted from C language or assembler language into an executable object, or a program written in one of these languages.

FIG. 1 is a drawing to explain an example of the operation performed by a conventional interrupt handling program when an exception occurs. Here, it is assumed that an overflow exception has occurred during sum-of-product iteration carried out by a program P1 written in the C language. This program P1 defines the variables ‘i’ and ‘sum’ as integers, and after performing prescribed pre-processing operations A such as register setting, performs, with regard to variables ‘i’ ranging from 0 to 127, (i) an operation B, (ii) the addition of a[i]×b[i] into the variable ‘sum’, and (iii) an operation C, whereupon it performs an exception handling operation D upon the occurrence of an overflow. Here, a and b are array variables with a size of 128. In this program P1, an overflow exception can occur during sum-of-product iteration.

In order to handle this unexpected exception, the processor has a function to generate an interrupt when the exception occurs, execute an interrupt handling program, and return to the existed state after the program execution. In order to enable the execution of this interrupt handling program when an exception occurs, special hardware is included in the processing unit of the processor.

At the right side of FIG. 1 is shown the construction of the hardware included in the processing unit that performs processing when the above exception occurs. The processing unit 10 has an interrupt controller 12 that performs pre-processing and post-processing in order to execute an interrupt handling program when an interrupt occurs, an exception status register 14 that stores the fact that an exception has occurred, an enable flag register 16 in which is set an enable flag that indicates whether or not an interrupt is permitted, a jump table 18 that stores a plurality of interrupt destination addresses, a branch address register 20, and a stack register 22 that, when an interrupt is generated, places data in registers or the count value in a program counter 24. When necessary pre-processing is performed by the interrupt controller 12 upon the occurrence of an interrupt, an interrupt handling program 26 is executed, and when this program is completed, the interrupt controller 12 performs post-processing and returns control to the original program P1. The jump table 18 stores interrupt handling program addresses corresponding to a plurality of exceptions, and the interrupt controller 12 distinguishes the type of exception based on the interrupt signal and enables branching to the corresponding address.

FIG. 2 is a drawing showing the sequence of an exception handling operation that uses the above interrupt handling program. The program P1 at the left side of the drawing is identical to the program P1 described with reference to FIG. 1. When, in the execution of the program P1, an overflow occurs as the result of computation and an overflow exception occurs in a ‘for statement’ during iteration from i=0 to i=127, an ALU, which comprises an arithmetic unit not shown in the drawings, supplies an exception notification signal to the processing unit 10, and the interrupt controller 12 in the processing unit 10 begins processing (S1). The interrupt controller 12 first writes an interrupt flag to the exception status register 14 and then stores (places, pushes) the address currently residing in the program counter 24, i.e., the address of the program currently being executed, in the stack register 22 (S2). In this push operation, data in various registers is also placed in the stack register 22. The interrupt controller 12 then confirms that the interrupt flag in the interrupt enable flag register 16 is in the enabled state, and obtains from the jump table 18 the address of the interrupt handling program corresponding to the exception that has occurred (S3). The address of the thus-obtained interrupt handling program is then written to the program counter 24 (S4), whereupon pre-processing for branching to the interrupt handling program is completed.

When pre-processing by the interrupt controller 12 is completed, the processor executes the interrupt handling program and performs an exception handling operation (S5). When this is completed, the interrupt controller 12 returns (pops) the return address and register data from the stack register 22 and writes the address to the program counter 24 (S6), and returns control to the program P1 (S7).

In the above operation, by pre-setting the enable flag in the interrupt enable flag register 16 to interrupt permitted (enabled) via a user program, the interrupt handling program can be set to run automatically in the background when an exception such as overflow occurs. However, because this interrupt handling program is normally run under the control of the operating system (OS), it is difficult or impossible to employ a user program to configure this operation to be executed. The above sequence describes the execution of an exception handling operation using an interrupt.

If the interrupt enable flag 16 corresponding to the occurrence of an overflow exception is set to disabled, the interrupt controller 12 in the arithmetic unit 10 only sets in the register 14 an exception status indicating that an overflow exception has occurred, and does not branch to the interrupt handling program 26. In this case, in the user program P1, even where an overflow exception occurs, only computation regarding variables from i=0 to i=127 is repeated, and the determination of whether or not an overflow has occurred after iteration is completed can be obtained from the status register 14.

The above exception handling method executes an interrupt handling program under the control of the OS while a user program is running, and it is difficult to perform a setting operation to permit the execution of a desired operation from the user program. Even if such a setting operation were possible, complex processing such as the changing of register values would be required, and would hardly enable unrestricted selection of an exception handling operation from a user program.

For example, a situation is presumed in which, during an operation that performs sum-of-product (SOP) iteration such as the user program P1 described above, processing that occurs after the moment that an overflow occurred would have to be terminated and the iteration routine exited. In other words, when an overflow occurs, because the correct operation result cannot be obtained even if SOP iteration is thereafter performed, there is no point to continuing the iteration operation.

In this situation, in order to exit the iteration operation using the interrupt controller 12 and the interrupt handling program 26 shown in FIGS. 1 and 2, it is necessary for the interrupt handling program 26 to branch to an address after the iteration operation in the user program P1. However, the execution of such an operation by the interrupt handling program 26 under the control of the OS would require complex settings and commands, and would not be practical. Moreover, it would entail the interrupt controller 12 executing pushing or popping to or from the stack register, resulting in wasteful overhead in order to perform a mere branching operation.

FIG. 3 is a drawing that shows an example in which a branching operation executed when an exception occurs is described in a user program. By adding the program command ‘if(overflow==true)break;’ in the for statement in the user program P2 by which the iteration operation is executed, monitoring as to whether the exception status register 14 indicating the occurrence of overflow has become ‘true’ can be performed each time, so that if an exception has occurred, branching to a branching destination command using a break command is enabled. In this example, it is assumed that the interrupt enable flag 16 is preset to disabled, which means that the interrupt handling program is not executed by the interrupt controller.

However, in the method described with reference to FIG. 3, the exception monitoring and branching command in the user program must be repeatedly performed in the for statement, and where an overflow exception does not occur, this leads to the repetition of a wasteful command. Furthermore, the execution of this command requires the processor to perform processing for a period of time, leading to a reduction in processor performance. Therefore, the method described with reference to FIG. 3 is a useful method in cases where the user program involves a relatively small number of iterations.

In addition, as described above, if the interrupt enable flag 16 is set to disabled in the user program pre-processing routine A, even when an exception occurs, iteration can be completed and the loop is exited without the performance of exception processing. Where a small number of iterations is involved, this method is somewhat more useful.

As described above, the methods for handling of an exception include (1) a method in which no processing is performed even when an exception occurs, (2) a method in which interrupt handling is performed using the interrupt controller and interrupt handling program shown in FIGS. 1 and 2 when an exception occurs, and (3) a method in which branching to a specified address is executed when an exception occurs.

However, a conventional processor includes only the exception handling means shown in FIGS. 1 and 2, and it is difficult to independently configure such an exception handling operation. Moreover, a conventional processor entails the problems that (i) it does not have a construction that permits dynamic selection of a plurality of exception handling operations in accordance with the internal and external status of the processor, and (ii) it is difficult to execute the optimal exception handling operation in accordance with the processing load on the processor.

### SUMMARY OF THE INVENTION

Accordingly, an object of the present invention is to provide a processor that can execute a selected operation through the free selection and setting of an exception handling operation from among a plurality of operations using a user program.

Another object of the present invention is to provide a processor that permits the free selection and setting of an exception handling program in accordance with the external and internal status of the processor using a user program.

In order to achieve these objects, according to one aspect of the present invention, the processor pertaining to the present invention comprises: a regular processing unit that performs processing in accordance with command codes supplied from a user program; and an exception handling command unit that, when an exception occurs, selects an operation and supplies a corresponding command code to the processing unit. The exception handling command unit has (i) an exception handling command memory that stores a plurality of exception handling commands that correspond to operation IDs, (ii) a selected operation ID register that stores the operation IDₛ set using the user program, (iii) an exception identification unit that receives an exception notification signal generated when an exception event occurs and determines that a prescribed exception event has occurred, and (iv) an exception handling command selection/output unit that reads out from the selected operation ID register the operation ID corresponding to the exception identified by the exception identification means, and outputs a command code of the exception handling command stored in the exception handling command memory in accordance with this operation ID.

In a preferred embodiment of the present invention, the exception handling command unit has a first status register that stores the processor's internal load status and a second status register that stores the external status provided from outside the processor, and the operation ID corresponding to the status stored in the first or second status register is set in the selected operation ID register via a user program. The exception handling command selection/output means outputs the command code of the exception handling command stored in the exception handling operation memory in accordance with this operation ID.

In a preferred embodiment of the present invention, a plurality of operation IDs are set in the selected operation ID register via the user program, the exception identification means generates the identified exception ID, and the exception handling command selection/output means reads out from the selected operation ID register the operation ID corresponding to the identified exception ID.

Because the processor of the present invention includes an exception handling command unit that stores a plurality of exception handling commands beforehand and outputs the command code for the exception handling operation set in the register via the user program, a desired exception handling operation may be executed in a short cycle simply by selecting and setting via a user program an exception handling operation to be executed when an exception occurs.

### BRIEF DESCRIPTION OF THE DRAWINGS

FIG. 1 is a drawing to explain an example of the operation performed by a conventional interrupt handling program when an exception occurs;

FIG. 2 is a drawing showing the sequence of the exception handling operation carried out by the interrupt handling program;

FIG. 3 is a drawing showing an example of the description of a branching operation that is carried out upon the occurrence of an exception and described in a user program;

FIG. 4 is a conceptual drawing of the present invention;

FIG. 5 is a summary construction diagram of the processor of an embodiment of the present invention;

FIG. 6 is a construction diagram of the exception handling command unit of an embodiment of the present invention;

FIG. 7 is a drawing showing an example of a first user program;

FIG. 8 is a drawing showing an example of a second user program;

FIG. 9 is a drawing showing an example of a third user program;

FIG. 10 is a drawing showing an example of a fourth user program; and

FIG. 11 is a construction diagram of the exception handling command unit 36 corresponding to the program shown in FIG. 10.

### DESCRIPTION OF THE PREFERRED EMBODIMENTS

An embodiment of the present invention is explained below with reference to the drawings. However, the protected scope of the present invention is not restricted by the embodiments described below, and extends to all inventions falling within the scope of the claims and to their equivalents.

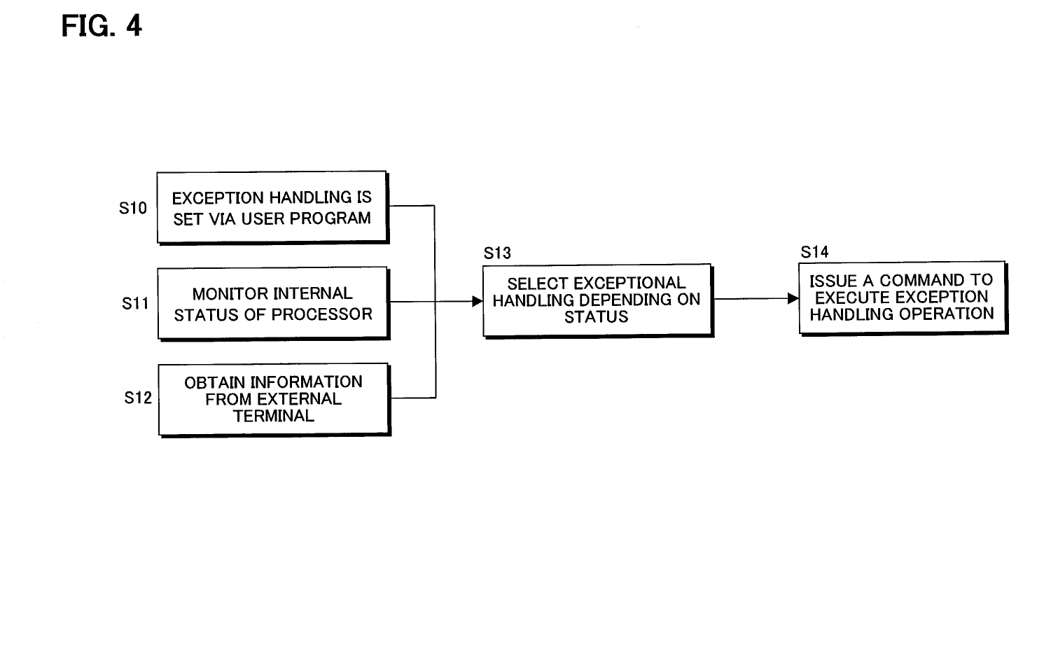

FIG. 4 is a conceptual drawing of the invention. In the present invention, when an operation to be executed when an exception occurs is set via a user program (S10), the processor selects at the time an exception occurs an exception handling operation corresponding to the type of exception that occurred (S13), and a command to execute that exception handling operation is issued to the regular processing unit (S14). In order to enable this operation, the processor has, in addition to a processing unit that decodes the command code from the program memory and performs processing, a memory that stores a plurality of exception handling operation codes, as well as an exception handling command unit that supplies to the processing unit the command code of the exception handling command corresponding to the occurrence of the exception.

Further, as shown in FIG. 4, the processor continuously monitors the its internal status (S11), obtains from an external terminal information regarding the external state of the processor (S12), and selects an exception handling operation in accordance with the obtained internal and external status information (S13).

Therefore, a desired exception handling operation may be executed in the background while a user program is running simply by selecting and setting via the user program an exception handling operation to be executed when an exception occurs. Furthermore, such setting may be performed in accordance with the processor's internal and external status, so that the optimal exception handling operation may be executed in accordance with such status in the background while the user program is running.

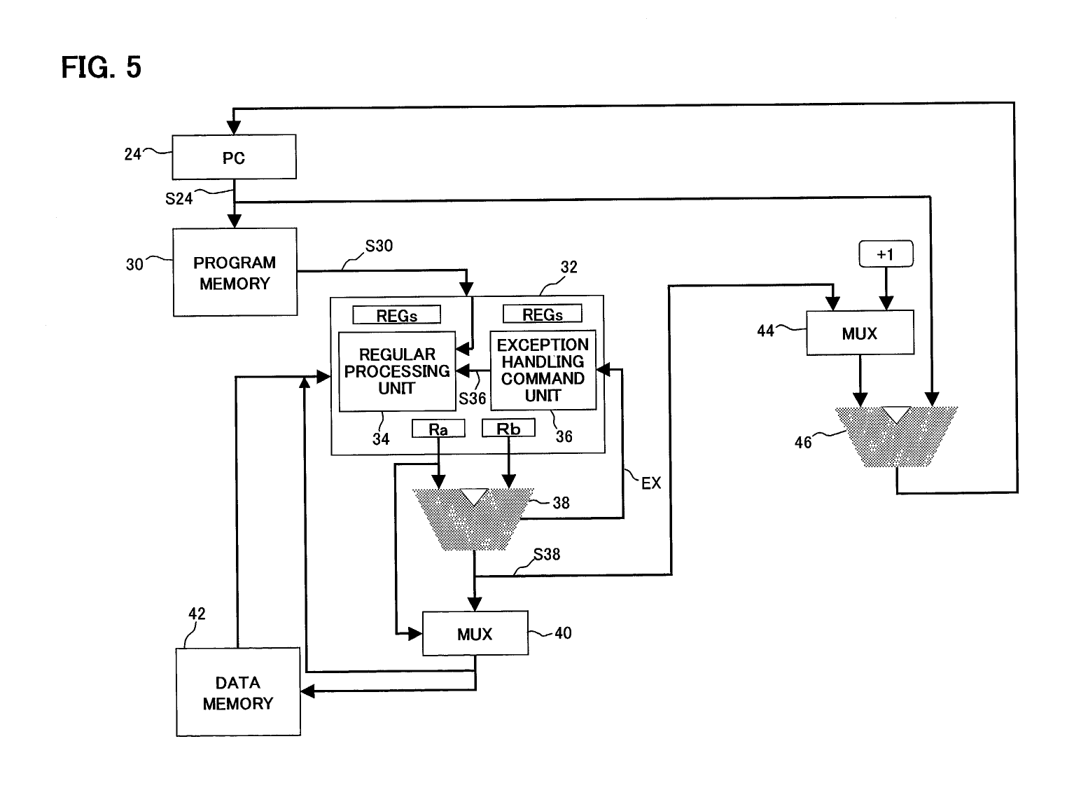

FIG. 5 is a summary construction diagram of the processor of this embodiment. The processor has a program memory 30 that stores the command codes for programs such as user programs, a program counter 24 that stores the addresses of the program memory, a processing block 32 that processes the command codes read out from the program memory 30, a first arithmetic unit 38 that processes data stored in the registers Ra and Rb in the processing block 32, and a data memory 42 in which data is stored.

The processing block 32 has a regular processing unit 34 that decodes command codes read out based on the address in the program counter 24, performs prescribed processing, and stores data in the registers Ra and Rb, as well as a group of various registers REG. The processor also includes a second arithmetic unit 46 to control the address in the program counter 24 and a multiplexer 44. Using the second arithmetic unit 46, the result of incrementing the address in units of one or adding of the relative address S38 is stored once more in the program counter 24 by the second arithmetic unit 46. In addition, the processor also includes a multiplexer 40 that selects either the data output from the first arithmetic unit 38 or the data in the register Ra.

We will now consider an example involving the execution of a user program that adds data Y to the data X in the data memory 42. This user program has, for example, the following four command codes: (1) read out the data X from the data memory 42 and store it in the register Ra; (2) read out the data Y from the data memory 42 and store it in the register Rb; (3) add together the data in the register Ra and the register Rb and store the sum in the register Ra; and (4) write the sum data in the register Ra to the address in which the data X was stored.

Therefore, the address of the command code (1) is stored in the program counter 24, and the command code (1) corresponding to this address S24 is read out from the program memory 30 and supplied to the regular processing unit 34 in the processing block 32. The regular processing unit 34 decodes the command code (1), sets the address of the data memory included in the command code in the register Ra, reads out the data X to the data memory 42, and stores the read out data X in the register Rb. Next, the address of the command code (1) is incremented up by one by the second arithmetic unit 46, and the result is stored in the program counter 24. The command code (2) corresponding to this address is read out from the program memory 30 and supplied to the regular processing unit 34. The regular processing unit 34 decodes the command code (2), sets the address of the data memory included in the command code in the register Ra, reads out the data Y to the data memory 42, and stores the read out data Y in the register Ra. Furthermore, the address in the program counter 24 is incremented up by one, and the corresponding command code (3) is read out from the program memory 30 and supplied to the regular processing unit 34. The regular processing unit 34 decodes the command code (3), adds together the data in the registers Ra and Rb in the first arithmetic unit 38, and stores the result data S38 in the register Ra. Furthermore, the address in the program counter is incremented, and the command code (4) is read out from the program memory 30 and supplied to the regular processing unit 34. Accordingly, the command code (4) is decoded, and the data in the register Ra is written to the region of the data memory 42 that contains the data X.

As described above, an operation corresponding to a command code is executed based on the supply of the command code S30 to the regular processing unit 34.

In addition to the regular processing unit 34, the processor of this embodiment has in the processing block 32 an exception handling command unit 36 that selects an operation to be executed when an exception occurs and supplies to the regular processing unit 34 the corresponding command code S36. This exception handling command unit 36 is a logic circuit unit that receives an exception notification signal EX generated by the arithmetic unit 38 upon the occurrence of an exception such as overflow, underflow or zero division, selects the exception handling operation set beforehand by the user program and corresponding to the type of exception that occurred, and supplies the command code S36 for that exception handling operation to the regular processing unit 34.

Therefore, when an exception occurs while a user program is running, because an exception handling operation preset in the user program is selected in the background and executed by the regular processing unit 34, a desired operation may be easily selected and set via a user program.

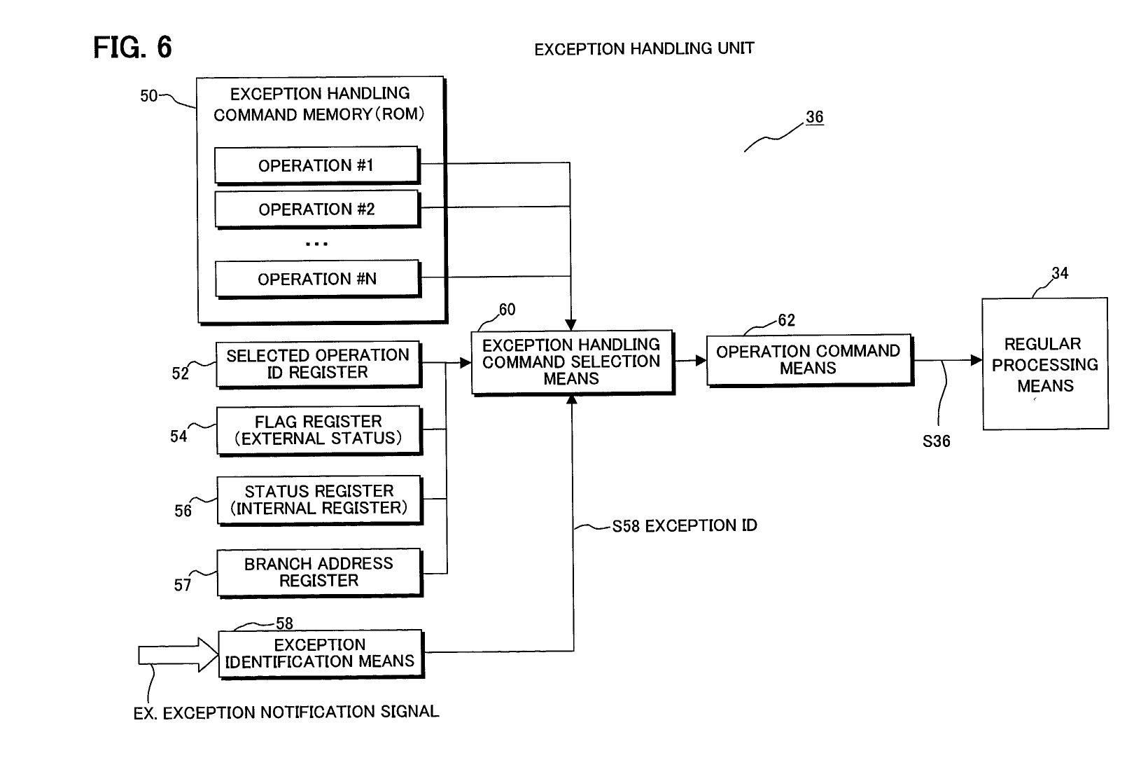

FIG. 6 is a construction diagram of the exception handling command unit of this embodiment. The exception handling command unit 36 has an exception handling command memory 50 in which are stored beforehand a plurality of commands for operations to be performed when an exception occurs. This exception handling command memory 50 comprises a ROM or a RAM in which command codes are initially loaded from a ROM not shown in the drawing, and stores a command code list consisting of a plurality of operation commands, numbered #1 through #N and each associated with an operation ID, to be executed when an exception occurs. The exception handling command unit 36 also has a selected operation ID register 52 that stores the user program-settable selected operation ID, a status register (first status register) 56 in which the processor's internal load status is stored, a flag register (second status register) 54 in which is stored the processor's external status supplied via a terminal outside the processor, and a branch address register 57 in which is stored a branch address corresponding to a branching instruction.

The exception handling command unit 36 has exception identification means 58 that receives a plurality of exception notification signals EX supplied by the arithmetic unit 38 or the like, determines that a prescribed exception has occurred, and outputs an identification signal or exception ID therefor. The exception identification means 58 outputs an identification signal S58 when a single exception is identified, and when a plurality of exceptions are identified, it outputs the exception IDs for those exceptions. When identifying a single exception, the identification signal S58 indicates the occurrence of an exception by ‘0’ (does not exist) or ‘1’ (exists), and when identifying a plurality of exceptions, the identification signal S58 becomes ‘0’ (do not exist) or the exception IDs (exist).

The exception handling command unit 36 also has exception handling command selection means 60 that, in response to the exception IDs supplied by the exception identification means 58, reads out from the selected operation ID register 52 the operation IDs corresponding to the exception IDs, and then reads out from the exception handling command memory 50 the operation commands corresponding to those operation IDs. The command code S36 for the operation commands selected by the exception handling command selection means 60 is output from an operation command means 62 to the regular processing unit 34.

In order to implement the functions described above, the selected operation ID register 52 is constructed such that it can store operation IDs corresponding to exception events that require handling. For example, where there are three types of exception events that require handling (overflow, underflow and zero division), three registers 52 that store the corresponding operation IDs are included. In this case, each register 52 is associated with an exception ID. The setting of an operation ID in a register 52 can be carried out in the same way as setting in other registers.

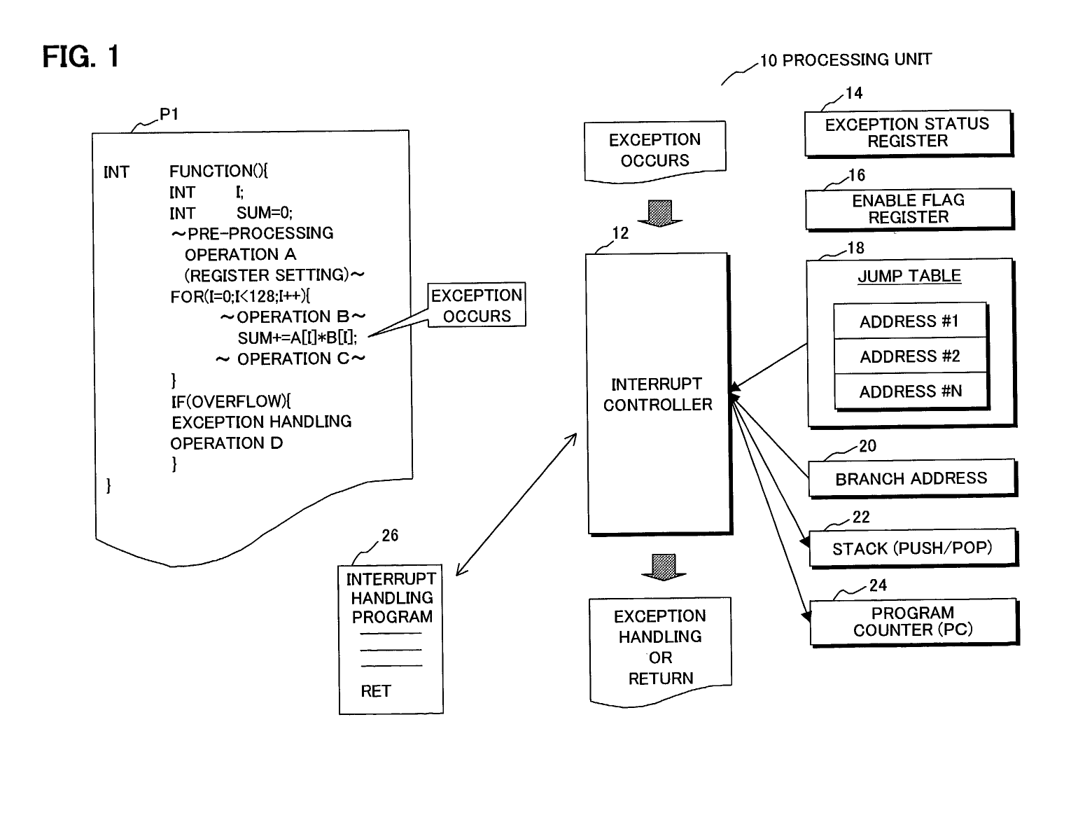

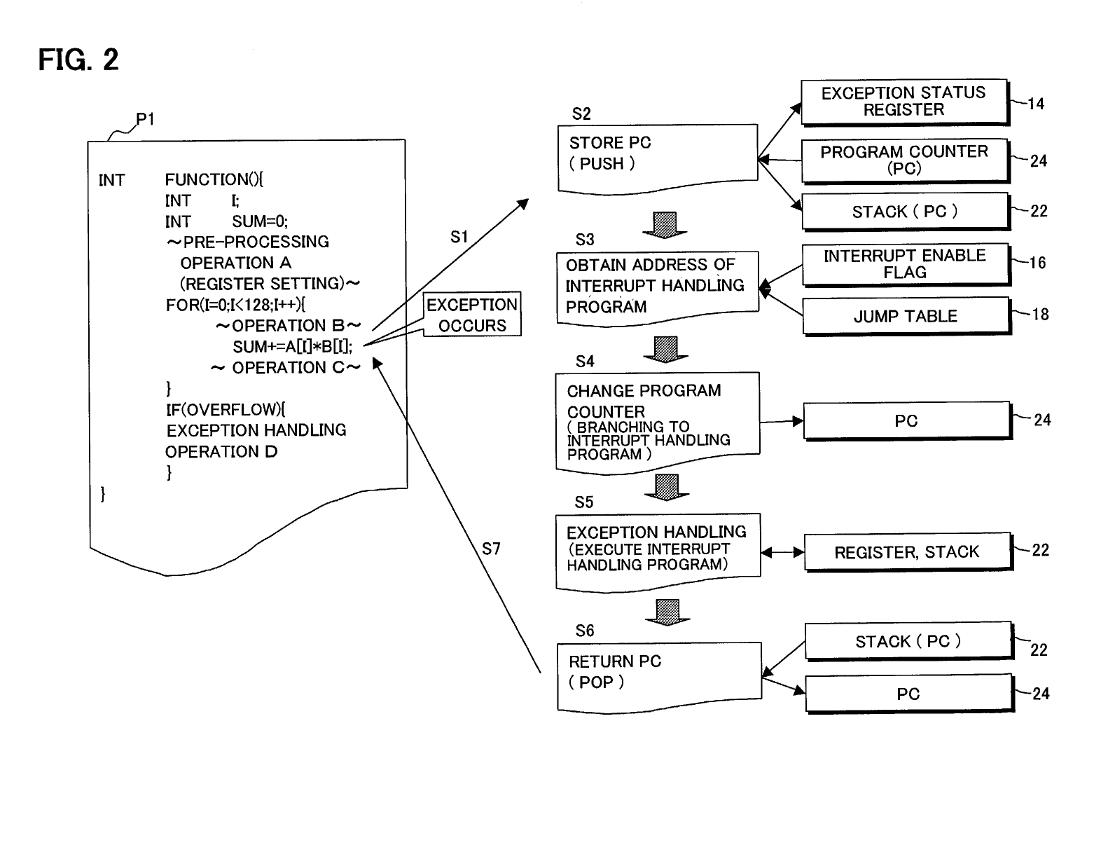

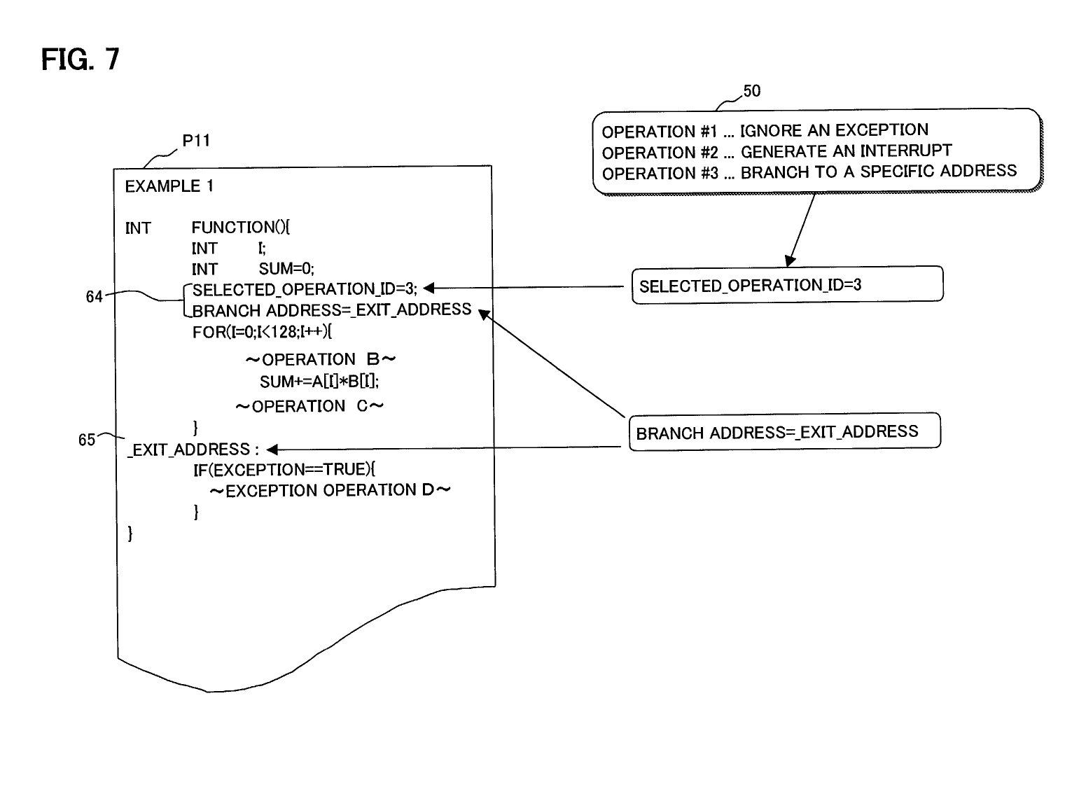

FIG. 7 is a drawing showing a first example of the user program. As indicated as a pre-processing operation A by the number 64 in the drawing, this program P11, unlike the program shown in FIGS. 1 and 2, sets the selected operation ID in the selected operation ID register 52 in the exception handling command unit 36 to ‘3’, and furthermore sets in the branch address register 57 the branch address ‘_exit_address’ needed for the branching instruction for operation ID=3. This branch address ‘_exit_address’ is described in a desired position after the for statement in the program P11.

Stored in the exception handling command memory 50 are three types of exception handling operations, for example. As shown at the upper right-hand corner of FIG. 7, the operation #1 is a command to ignore the exception and perform no processing, the operation #2 is a command to generate an interrupt as shown in FIGS. 1 and 2 and execute a prescribed interrupt handling program, and the operation #3 is a command to perform branching to a specified address (i.e., the address in the branch address register) when an exception occurs.

As described above, the pre-processing carried out by the user program in FIG. 7 sets the operation ID ‘3’ and ‘_exit_address’ in the registers 52 and 57, respectively, in the exception handling command unit 36. As a result, when an overflow occurs while an arithmetic operation is underway, in the exception handling command unit of FIG. 6, the exception identification means 58 determines the existence of the overflow from the exception notification signal EX and supplies the exception ID or exception signal S58 corresponding to the identified exception to the exception handling command selection means 60. The exception handling command selection means 60 reads out from the selected operation ID register 52 the operation ID set to correspond to the exception ID, and reads out the branching command for the operation #3 corresponding to that operation ID from the exception handling command memory 50. The branching destination address set in the branch address register 57 and the read out branching command code are then supplied by the operation command means 62 to the regular processing unit 34.

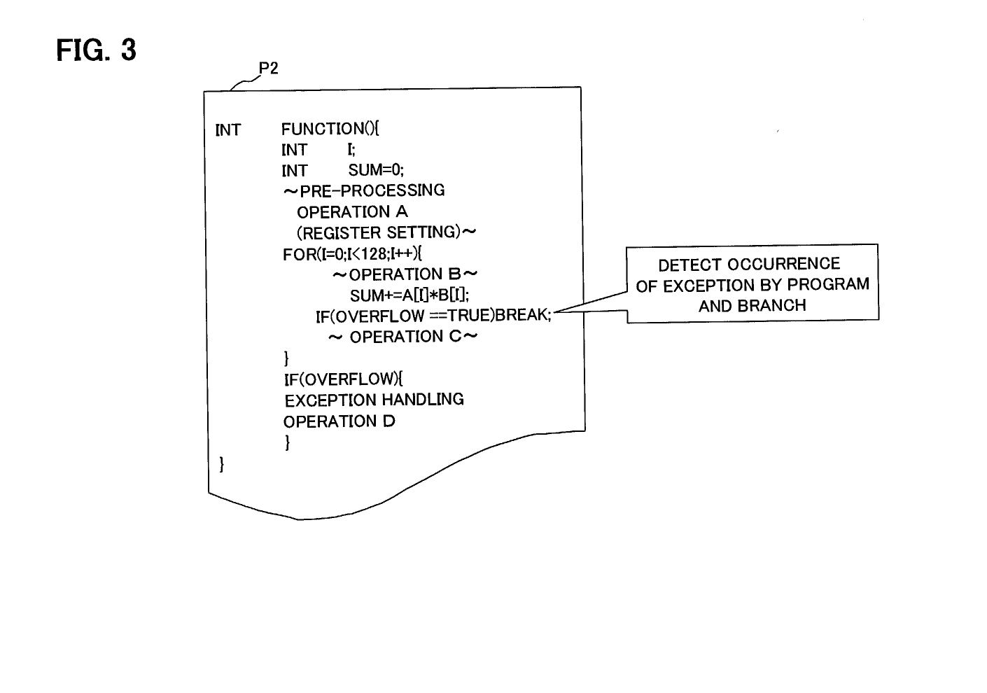

Therefore, in the user program P11, simply by setting in the registers 52 in the exception handling command unit as a pre-processing routine the operation IDs for the operation to be performed when an exception occurs, the selected operation can be run in the background when an exception occurs, irrespective of the program commands shown in FIG. 3. The setting in the registers of the exception handling command unit 36 can be carried out in the same manner as the setting in the registers of the regular processing unit 34. Only the number of registers has increased.

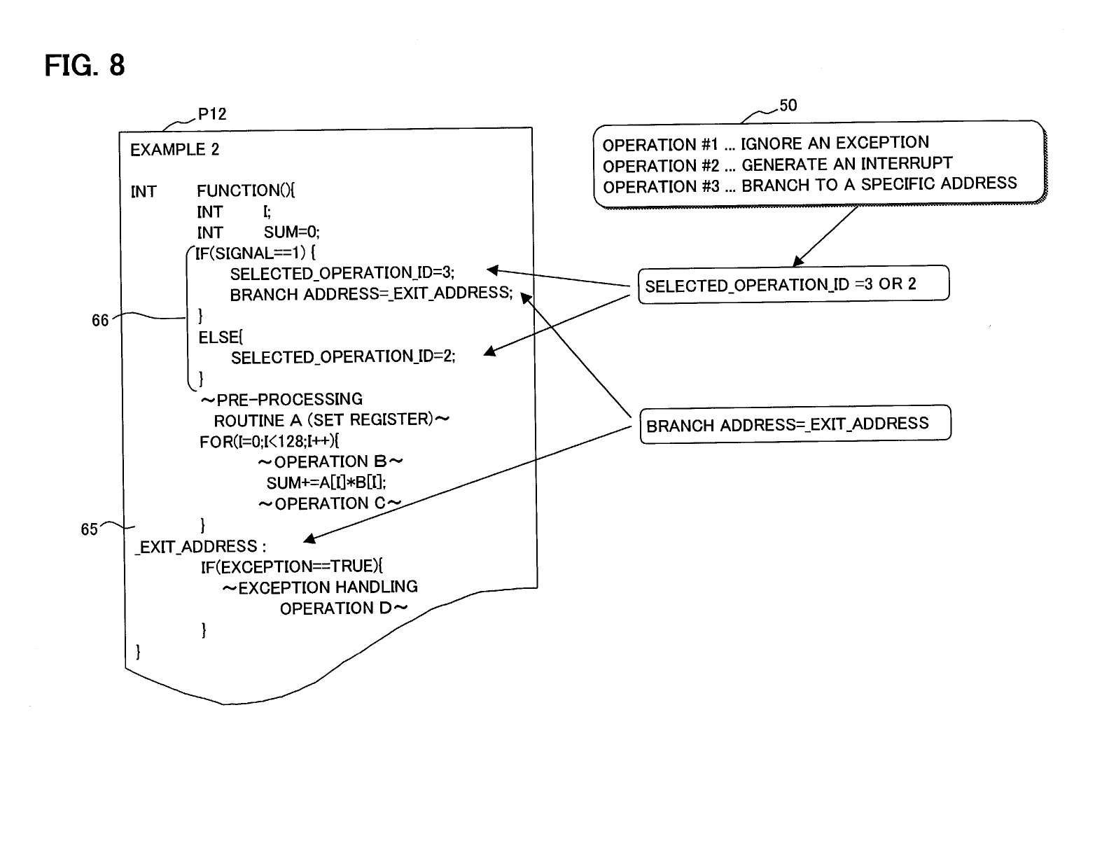

FIG. 8 is a drawing showing a second example of the user program. This user program P12 has a program code 66 that, before the pre-processing routine A, executes an if statement, and then selects and sets an operation to be performed when an exception occurs in accordance with the value of the external terminal Signal. Otherwise, it is identical to the program P11 of FIG. 7. In this example as well, three operations #1, #2 and #3 are stored beforehand in the exception handling command memory 50.

The external signal Signal input via the external terminal is a signal related to the external status of the processor. For example, it is set in the flag register 54 that when the external processing load on the processor is heavy, Signal=1, and that when the processing load is light, Signal=0.

Accordingly, when the program code 66 is executed, either the relatively light-load operation ID ‘3’ or the relatively heavy-load operation ID ‘2’ is set in the selected operation ID register 52 in accordance with the external status set in the flag register 54. When the external processing load is heavy, the relatively light-load operation ID ‘3’ is set in the register 52, while when the external processing load is light, the relatively heavy-load operation ID ‘2’ is set in the register 52. When the operation ID ‘3’ corresponding to the branching command is set, the associated branch address ‘_exit_address’ is set in the branch address register 57.

As described above, by setting an exception handling operation corresponding to the external load status in the register 52 of the exception handling command unit 36 using an if statement in a part of a pre-processing routine, if an exception event such as an overflow thereafter occurs during the execution of a repetitive arithmetic operation, the optimal exception handling operation in consideration of such status can be executed in the background while a user program is running. In the case of the operation #2, in the exception handling command unit 36, the interrupt command code is read out from the exception handling command memory 50 and supplied to the regular processing unit 34, which executes, in accordance with the interrupt command, the processing via the interrupt controller as well as the interrupt handling program. The explanation provided with reference to FIGS. 1 and 2 applies here.

The interrupt handling program corresponding to the operation #2 is a program that counts the number of occurrences of overflow, for example, and in this case, the number of overflows occurring is used in order to seek the correct result of SOP iteration. In the case of the branching command of operation #3, because branching is carried out to a branch address outside the computation loop during SOP iteration, the load on the processor is reduced.

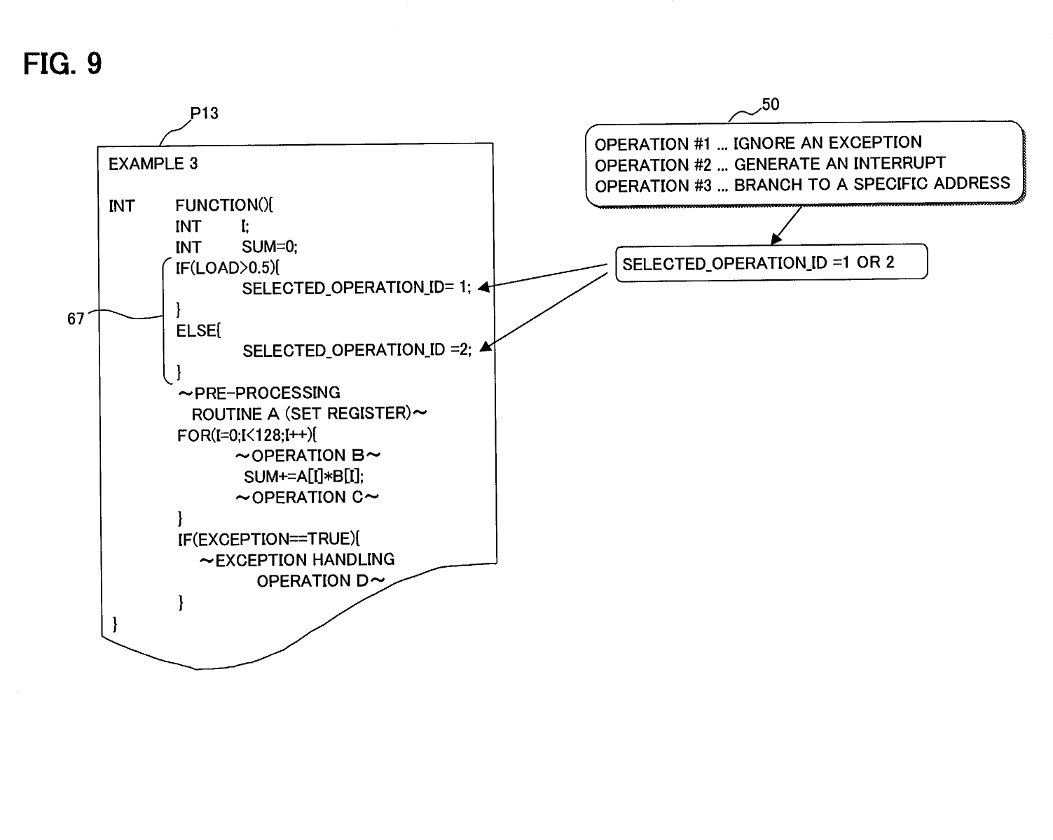

FIG. 9 is a drawing showing a third example of the user program. This user program P13 has a program code 67 that executes an if statement before the pre-processing routine A, and selects and sets an operation to be performed when an exception occurs in accordance with the value of the data ‘Load’ in the status register 56 in which the internal status is stored. In this example as well, three operations #1, #2 and #3 are stored beforehand in the exception handling command memory 50.

The data Load indicating the internal status is set in the status register 56. For example, an index value indicating the current internal processing load on the processor is sought in response to the cumulative time during which a sleep mode was active during a certain immediately preceding interval, and this index is set in the status register 56 as the data Load having a range between 0 and 1.0. In this case, where the load index Load is greater than 0.5, indicating a heavy load, the relatively light operation ID ‘1’ indicating that no operation is to be performed when an exception occurs is set in the selected operation ID register 52. Conversely, where the load index Load is smaller than or equal to 0.5, indicating a light load, the operation ID ‘2’ indicating that regular interrupt handling is to be carried out when an exception occurs is set in the selected operation ID register 52.

Because the branch command operation #3 is not set in the program P13 of FIG. 9, setting in the branch address register 57 is not performed.

As a result of the exception handling operation setting carried out in the pre-processing routine described above, when an overflow exception occurs during SOP iteration, either the exception handling operation #1 in which no operation is performed or the regular interrupt handling operation #2 is carried out in the background when an exception occurs.

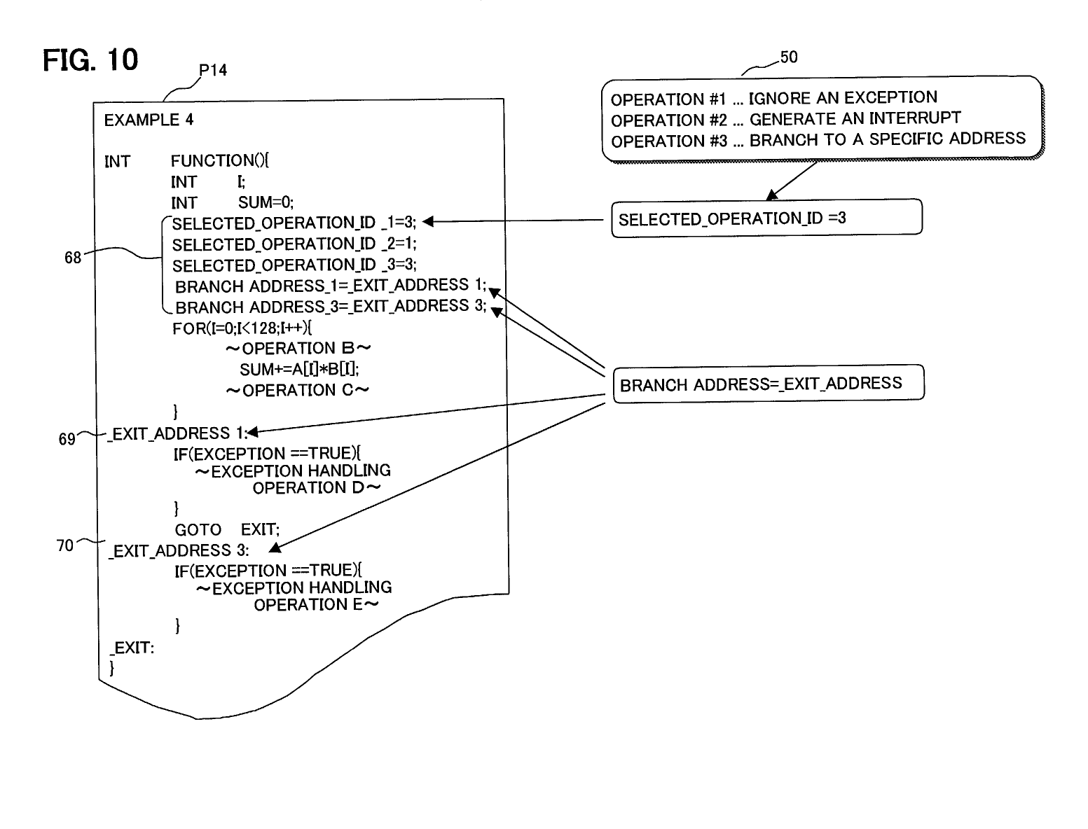

FIG. 10 is a drawing showing a fourth example of the user program. In this program P14, as a pre-processing routine 68, operation ID setting in the three selected operation ID registers 52 and setting of the branch addresses corresponding to the branching operations #1 and #3 in the branch address register 56 are carried out. In addition, the two branch addresses above are described in the program with reference to the symbols 69 and 70 in the drawing.

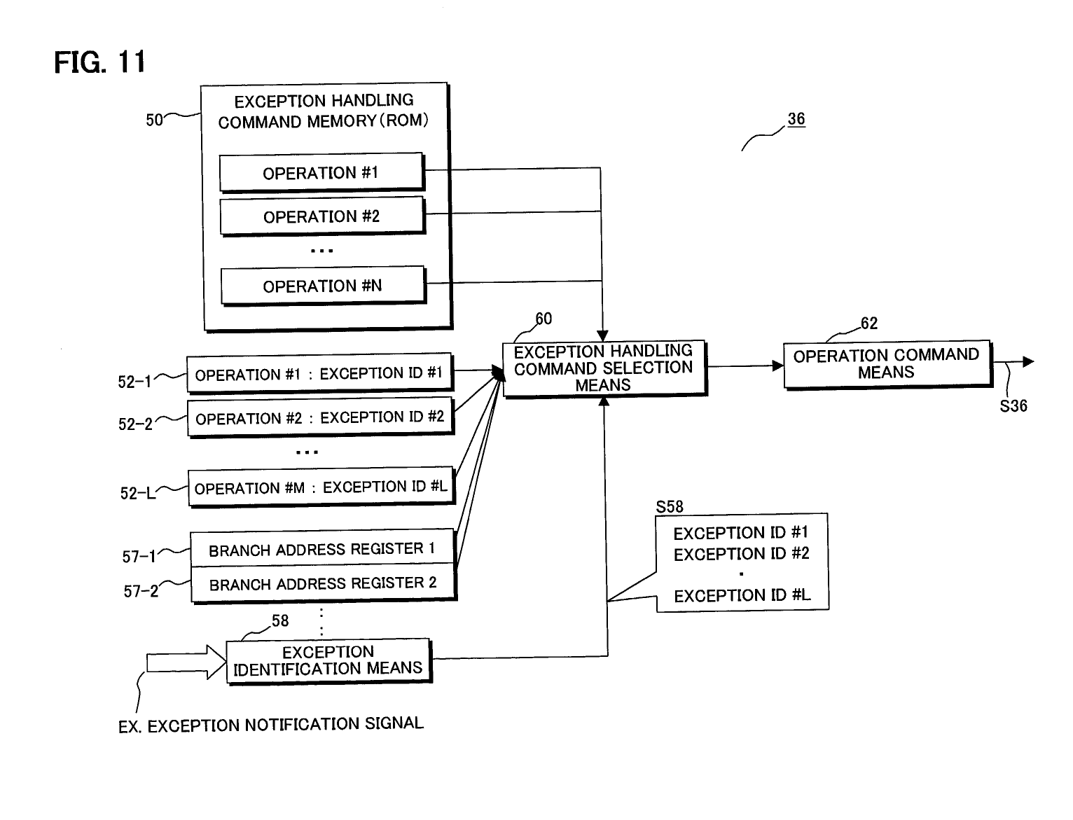

FIG. 11 is a construction diagram of the exception handling command unit 36 corresponding to the program shown in FIG. 10. The exception handling command unit 36 has L number of selected operation ID registers 52-1 through 52-L, corresponding to exception IDs #1 through #L identified and output by the exception identification means 58. In the program P14 of FIG. 10, the operation IDs corresponding to the three types of exceptions are set in the three registers 52-1, 52-2 and 52-3 as ‘3’, ‘1’ and ‘3’, respectively. For example, when an overflow (exception ID=#1) occurs, ‘3’ is set in the selected operation ID register 52-1 as an operation ID, and a branching command is set to be executed. When an underflow (exception ID=#2) occurs, ‘1’ is set in the selected operation ID register 52-2 as an operation ID, and no operation is set to be executed. When zero division (exception ID=#3) occurs, ‘3’ is set in the selected operation ID register 52-3 as an operation ID.

At the same time, branch addresses are set in the branch address registers 57-1 through 57-L corresponding to the L number of selected operation ID registers 52. In the example of the program P14 of FIG. 10, the respective branch addresses are set in the branch address registers 57-1 and 57-3.

Together with the above setting, when one of the above three exceptions occurs during subsequent SOP iteration, the exception identification means 58 outputs the exception ID to the exception handling command selection means 60 based on the received exception notification signal EX. The exception handling command selection means 60 reads out the operation ID in the selected operation ID register 52-1 through 52-L that corresponds to the exception ID, and reads out the corresponding command code from the exception handling command memory 50. Where the command code is a branch command, the corresponding branch address is read out from the branch address register 57 and the operation command code and the necessary branch address are output by the operation command means 62.

As described above, because the processor of this embodiment has, among other things, an exception handling command unit 36 that has an exception handling command memory that stores a plurality of exception handling commands and a selected operation ID register or registers 52 in each of which is set an operation to be performed when an exception occurs; a selected exception handling operation can be set to run in the background when an exception occurs simply by setting desired exception handling operations in the selected operation ID registers via a user program.

Using the present invention, an exception handling operation can be executed in the background simply by setting via a user program a desired operation to be executed when an exception occurs. Furthermore, by selectively setting this operation to be performed in accordance with the internal and external status of the processor, the optimal exception handling operation can be performed.

What is claimed is:

1. A processor for performing prescribed operations, said processor comprising:
a regular processing unit that is supplied with a command code for a user program and performs an operation corresponding to said command code; and
an exception handling command unit that selects an operation to be performed when an exception event occurs and supplies the corresponding command code to said regular processing unit; and
wherein said exception handling command unit comprises:
an exception handling command memory in which a plurality of exception handling commands are stored in association with operation IDs;
a selected operation ID register in which is stored an operation ID set via said user program;
an exception identification unit that receives an exception notification signal generated when the exception event occurs and identifies that a prescribed exception event has occurred; and
an exception handling command selection/output unit that reads out from said selected operation ID register the operation ID corresponding to the exception identified by the exception identification unit and outputs, in accordance with the operation ID, a command code for the exception handling command stored in said exception handling command memory.

2. The processor according to claim 1, wherein said exception handling command unit has a first status register that stores a processor's internal load status, and the operation ID is set in said selected operation ID register via said user program in accordance with the load status stored in said first status register.

3. The processor according to claim 1, wherein said exception handling command unit has a second status register that stores an external load status supplied from outside the processor, and the operation ID is set in said selected operation ID register via said user program in accordance with the load status stored in said second status register.

4. The processor according to claim 1, wherein said exception handling command unit has a branch address register that stores a branch address set using said user program, and the branch address for said operation ID is read out from the branch address register.

5. The processor according to claim 1, wherein a plurality of said selected operation ID registers are provided corresponding to a plurality of types of exception events, and the operation ID is read out from the selected operation ID register corresponding to the exception event identified by said exception identification unit.

6. The processor according to claim 5, wherein said processor further comprises a plurality of branch address registers that each store a branch address for an exception handling operation corresponding to an operation ID stored in the selected operation ID register, and when the operation ID read out from said selected operation ID register corresponds to an exception handling operation that includes a branch command, the branch address corresponding to said branch command is read out from said branch address registers.

7. The processor according to claim 4, wherein said exception handling command selection/output unit supplies to said regular processing unit the branch command code and the branch address read out from said branch address register.

8. The processor according to claim 6, wherein said exception handling command selection/output unit supplies to said regular processing unit the branch command code and the branch address read out from said branch address register.

9. The processor according to claim 1, wherein said exception events include at least overflow, underflow or zero division.

10. The processor according to claim 1, wherein said exception handling commands include at least a first operation in which the exception event is ignored and no processing is performed, a second operation in which an interrupt is generated and prescribed processing is performed, and a third operation in which branching is executed to a branch address.

11. The processor according to claim 1, wherein said regular processing unit decodes the supplied command code and executes an operation corresponding to the command code.

12. A processor for performing prescribed operations, said processor comprising:
a regular processing unit that is supplied with the command code for a user program and performs an operation corresponding to said command code; and
an exception handling command unit that has an exception handling command memory for storing a plurality of exception handling commands to be used when an exception event occurs, and a selected operation ID register for storing an operation ID set using said user program, and that reads out from said selected operation ID register in accordance with an exception notification signal generated when an exception event occurs, the operation ID corresponding to the exception event that occurred, reads out from said exception handling command memory the exception handling command corresponding to the operation ID, and supplies a command code for the exception handling command to said regular processing unit.

13. The processor according to claim 12, wherein said exception handling command unit has a first register that stores an internal load status of the processor, and the operation ID is set in said selected operation ID register via said user program in accordance with the internal load status stored in said first status register.

14. The processor according to claim 12, wherein said exception handling command unit has a second register that stores an external status supplied from outside the processor, and the operation ID is set in said selected operation ID register via said user program in accordance with the external status stored in said second status register.
